(19) United States
(12) Patent Application Publication
(10) Pub. No.: US 2014/0293003 A1
(43) Pub. Date: Oct. 2, 2014

(54) METHOD FOR PROCESSING A STEREOSCOPIC IMAGE COMPRISING AN EMBEDDED OBJECT AND CORRESPONDING DEVICE

(71) Applicant: THOMSON LICENSING, Issy de Moulineaux (FR)

(72) Inventors: Philippe Robert, Rennes (FR); Alain Verdier, Vern Sur Seiche (FR); Matthieu Fradet, Chanteloup (FR)

(73) Assignee: THOMSON LICENSING a corporation

(21) Appl. No.: 14/355,837

(22) PCT Filed: Oct. 30, 2012
(86) PCT No.: PCT/EP2012/071440

§ 371 Date: May 1, 2014

(30) Foreign Application Priority Data
Nov. 7, 2011 (FR) 1160083

(51) Int. Cl. H04N 13/00

(52) U.S. Cl. CPC H04N 13/004; H04N 13/0022
USPC 348/42

(57) ABSTRACT

The invention relates to a method for processing a stereoscopic image comprising a first image L and a second image R, an object being embedded on the first and second images modifying the initial video content of pixels associated with the embedded object on the first and second images. In order to ensure coherence between the disparity associated with the embedded object and the video information associated with the pixels of first and second images, the method comprises steps for:
detecting the position of the embedded object in the first and second images,
estimating the disparity between the first image and the second image on at least part of the first and second images comprising said embedded object,
determining the smallest depth value in said at least one part of images comprising the embedded object according to estimated disparity information,
assigning a depth to the embedded object for which the value is less than said smallest depth value.

The invention also relates to a module for processing a corresponding stereoscopic image.

### 1. DOMAIN OF THE INVENTION

The invention relates to the domain of image or video processing and more specifically to the processing of three-dimensional (3D) images and/or video comprising an embedded object. The invention also relates to the domain of estimation of disparity and image interpolation.

### 2. PRIOR ART

According to the prior art, it is known to add the information to a video stream of images generated by capture using a camera or by image synthesis via computer. The information added corresponds for example to a logo appearing in a given part of images of the video stream, to sub-titles illustrating speech between the personalities of the video stream, to text describing the content of images of the video stream, or to the score of a match. This information is generally added in post-production by embedding on the original images, that is to say on the images originally captured using the camera or via image synthesis. This information is advantageously embedded in such a way that it is visible when the video stream is displayed on a display device, that is to say that the video information of pixels of the original images are modified by an item of video information enabling the information to be embedded to be displayed.

In the case of a 3D image video stream, for example a video stream of stereoscopic images, each stereoscopic image is composed of a left image representing the scene filmed or synthesized according to a first viewpoint and a right image representing the same scene but filmed or synthesized according to a second viewpoint offset according to a horizontal axis of a few centimetres (for example 6.5 cm) with respect to the first viewpoint. When information must be embedded (or inlayed or encrusted) for display in the stereoscopic image, the information is embedded in the right image and the same information is embedded in the left image replacing the video information of pixels originating in left and right images with video information enabling the information to be embedded to be displayed. Generally, the information to be embedded is added to the stereoscopic image in a way so that it is displayed in the image plane during the display of the stereoscopic image so that this embedded information is clearly visible to all spectators. To do this, the information to be embedded is embedded (or inlayed or encrusted) in the left and right images of the stereoscopic image with a null disparity between the left image and the right image, that is to say that the pixels for which the video information is modified to display the information to be embedded are identical in the left image and the image, that is to say that they have the same coordinates in each of the left and right images according to a reference common to each left and right image. One of the problems engendered by such an embedding (or inlaying or encrusting) is that the embedded information may replace pixels in each of the left and right images associated with a video content, that is to say a stereoscopic image object, for which the disparity is for example negative, that is to say for which the disparity is such that the object will be displayed in the foreground during the display of the stereoscopic image. In fact, during the display of the stereoscopic image, the embedded information for which the associated disparity is null will appear in front of an object for which the associated disparity is negative while if it is attached purely and simply to the disparities associated with the embedded information and the object, the object should appear in front of the embedded information. This problem causes more specifically errors when the processes of estimation of disparity or interpolation of images are applied to the stereoscopic image.

Such a conflict between the video associated with the embedded information and the associated disparity is shown in FIG. 2A. FIG. 2A shows a 3D environment or a 3D scene viewed from two viewpoints, that is to say a left viewpoint L 22 and a right viewpoint R 23. The 3D environment 2 advantageously comprises a first object 21 belonging to the environment as it was captured for example using two cameras left and right. The 3D environment 2 also comprises a second object 20 that was added, that is to say embedded, onto the left and right images captured by the left and right cameras, for example embedded in post-production. The second object 20, called the embedded object in the remainder of the description, is positioned at the point of convergence of left 22 and right 23 viewpoints, which is to say that the disparity associated with the embedded object is null. The first object 21 appears in the foreground in front of the embedded object, which is to say that the disparity associated with the first object 21 is negative or that the depth of the first object 21 is less than the depth of the embedded object 20.

The left 220 and right 230 images shown in FIG. 2A respectively show the left viewpoint 22 and the right viewpoint 23 of the 3D environment 2 in the case where there is coherence between the disparity associated with each of the objects 20 and 21 and the video information (for example a level of grey coded on 8 bits for each colour red R, green G, blue B) associated with the pixels of each of the images 220 and 230. As this appears clearly with respect to the left 220 and right 230 images, the representation of the embedded object 200 in each of the left 220 and right 230 images appears well behind the representation of the first object 210 as the depth associated with the first object is less than that associated with the embedded object. In this case, the video information associated with each of the pixels of left 220 and right 230 images corresponds to the video information associated with the object having the least depth, in this case the video information associated with the first object 210 when the first object occludes the embedded object 200 and the video information associated with the embedded object 200 when the latter is not occluded by the first object 210. According to this case, at the display of the stereoscopic image comprising the left image 220 and the right image 230 on a 3D display device, the embedded object will be in part occluded by the first object 21. According to this example, there will be no conflict between the disparity information associated with the objects and the video information associated with the same object but this example has the disadvantage that the embedded object will be partially occluded by the first object, which may be problematic if the embedded object is supposed to be always visible to a spectator looking at the display device (for example when the embedded object corresponds to subtitles, a logo, a score, etc.).

A conflict problem occurs if the object 20 is simply embedded, by superposition onto the content of images, to be always visible, and if it is placed at the same positions as previously in the 2 images that is to say that it appears further away than the object 21. As a result, it appears in front of the object 21 as it occludes it, but behind this object in terms of distance.

The left 221 and right 231 images respectively show the left viewpoint 22 and the right viewpoint 23 of the 3D environment 2. In this case, there is conflict between the disparity information associated with the objects and video information associated with the same object. The depth associated with the embedded object is greater than the depth associated with the first object, the disparity associated with the embedded object 20 being null (as this appears clearly with respect to the images 221 and 231 as the position of the embedded object 200 is identical on each of these images, that is to say the position of the pixels associated with the representation of the embedded object 200 according to the horizontal axis is identical in the two images, there is no horizontal spatial offset between the representation of the embedded object 200 in the left image 221 and the representation of the embedded object 200 in the right image 231) and the disparity associated with the first object 21 being null negative (as appears clearly with respect to images 221 and 231 as the position of the first object 210 is offset according to a horizontal axis between the left image 221 and the right image 231, that is to say the position of the pixels associated with the representation of the first object 210 according to the horizontal axis is not identical in the two images, the first object appearing more to the right in the left image 221 than in the right image 231). Relating to video information associated with the pixels of left and right images, it appears clearly that the video information associated with the pixels associated with the embedded object 200 corresponds to the video information associated with the embedded object 200, without taking account of the disparity information. The embedded object thus appears in the foreground of the left image 221 and the right image and partially occludes the first object. At the display of the stereoscopic image comprising the left 221 and right 231 image, there is a display fault as the disparity information associated with the first object 21 and the embedded object 20 are not coherent with the video information associated with these same objects. Such an implementation example also poses problems when the disparity between the left image and the right image is estimated based on a comparison of video values associated with the pixels of the left image and the pixels of the right image, the objective being to match any pixel of the left image with a pixel of the right image (or inversely) in order to deduce the horizontal spatial offset representative of the disparity between the two matched pixels.

### 3. SUMMARY OF THE INVENTION

The purpose of the invention is to overcome at least one of these disadvantages of the prior art.

More specifically, the purpose of the invention is particularly to reduce the display faults of an object embedded in a stereoscopic image and to render coherent the video information displayed with the disparity information associated with the embedded object.

The invention relates to a method for processing a stereoscopic image, the stereoscopic image comprising a first image and a second image, the stereoscopic image comprising an embedded object, the object being embedded onto the first image and onto the second image while modifying the initial video content of pixels of the first image and of the second image associated with the embedded object. In order to reduce the display faults of the embedded object and provide coherence between the video information and the depth associated with the embedded object, the method comprises steps for:
determining at least one pixel of the first image occluded in the second image on at least part of the first and second images comprising the embedded object,
for at least one horizontal line of pixels of the first image comprising a group of at least one occluded pixel, detection of an embedding error of the object according to membership of a group to the embedded object and depth values associated with the pixels surrounding the group and adjacent to the group on the at least one horizontal line,
assigning of a depth to the embedded object for which the value is less than a minimal depth value if an embedding error is detected, the minimal depth value corresponding to the smallest depth value associated with the pixels surrounding the group and adjacent to the group on the at least one horizontal line.

Advantageously:
if the first image is a left image, an embedding error is detected if:
   the group of at least one occluded pixel belongs to the same object as the pixel adjacent to the group and situated right of the group, or
   the depth associated with the pixel adjacent to the group and situated left of the group is less than the depth associated with the pixel adjacent to the group and situated right of the group, the group belonging to the same object as the pixel adjacent to the group and situated left of the group.
if the first image is a right image, an embedding error is detected if:
   the group of at least one occluded pixel belongs to the same object as the pixel adjacent to the group and situated left of the group, or
   the depth associated with the pixel adjacent to the group and situated right of the group is less than the depth associated with the pixel adjacent to the group and situated left of the group, the group belonging to the same object as the pixel adjacent to the group and situated right of the group.

According to an additional characteristic, membership of the group to the embedded object is determined by comparison of at least one property associated with the group and to the pixels of the embedded object, the at least one property belonging to a set of properties comprising:
a colour,
an associated motion vector.

According to a particular characteristic, the method comprises a step of detection of the position of the embedded object based on the stationary aspect of the embedded object over a determined time interval.

Advantageously, the method comprises a step of detection of the position of the embedded object based on the at least one property associated with the embedded object the at least one property associated with the embedded object belonging to a set of properties comprising:
a colour,
a form,
a transparency level,
a position index in the first image and/or the second image.

Advantageously, the method also comprises a step of determination of an item of disparity information representative of disparity between the first image and the second image on at least one part of the first and second images comprising said embedded object.

According to another characteristic, the assigning of a depth to the embedded object is carried out via horizontal translation of pixels associated with the embedded object in at least one of the first and second images, an item of video information and an item of disparity information being associated with the pixels of the at least one of the first and second images uncovered by the horizontal translation of pixels associated with the embedded object by spatial interpolation of video information and disparity information associated with the neighbouring pixels of uncovered pixels.

The invention also relates to a module for processing a stereoscopic image, the stereoscopic image comprising a first image and a second image, the stereoscopic image comprising an embedded object, the object being embedded onto the first image and onto the second image while modifying the initial video content of pixels of the first image and of the second image associated with the embedded object, the module comprising:
means for detecting at least one pixel of the first image occluded in the second image on at least part of the first and second images comprising the embedded object,
means for detecting an embedding error of the object, for at least one horizontal line of pixels of the first image comprising a group of at least one occluded pixel, according to membership of the group to the embedded object and depth values associated with the pixels surrounding the group and adjacent to the group on the at least one horizontal line,
the image processing module comprising in addition:
means for assigning of a depth to the embedded object for which the value is less than a minimal depth value if an embedding error is detected, the minimal depth value corresponding to the smallest depth value associated with the pixels surrounding the group and adjacent to the group on the at least one horizontal line.

The invention also relates to a display device comprising a module for processing a stereoscopic image.

### 4. LIST OF FIGURES

The invention will be better understood, and other specific features and advantages will emerge upon reading the following description, the description making reference to the annexed drawings wherein:

FIG. 1 shows the relationship between the depth perceived by a spectator and the parallax effect between the first and second images of a stereoscopic image, according to a particular embodiment of the invention,

FIG. 2A shows the problems engendered by the embedding of an object in a stereoscopic image, according to an embodiment of the prior art,

FIG. 2B shows the perception of occluded parts in each of the first and second images of FIG. 2A in the presence of embedding error, according to a particular embodiment of the invention,

FIG. 2B shows the perception of occluded parts in each of the first and second images of FIG. 2A in the absence of embedding error, according to a particular embodiment of the invention,

FIG. 3 shows a method for detection of occlusions in one of the images forming a stereoscopic image of FIG. 2A, according to a particular embodiment of the invention,

FIG. 4 shows a method for processing a stereoscopic image comprising an embedded object of FIG. 2A, according to a particular embodiment of the invention,

FIG. 5 diagrammatically shows the structure of a processing unit of a stereoscopic image of FIG. 3A, according to a particular embodiment of the invention,

FIG. 6 shows a method for processing a stereoscopic image of FIG. 2A implemented in a processing unit of FIG. 5, according to a first particular embodiment of the invention,

FIG. 7 shows a method for processing a stereoscopic image of FIG. 2A implemented in a processing unit of FIG. 5, according to a second particular embodiment of the invention.

### 5. DETAILED DESCRIPTION OF EMBODIMENTS OF THE INVENTION

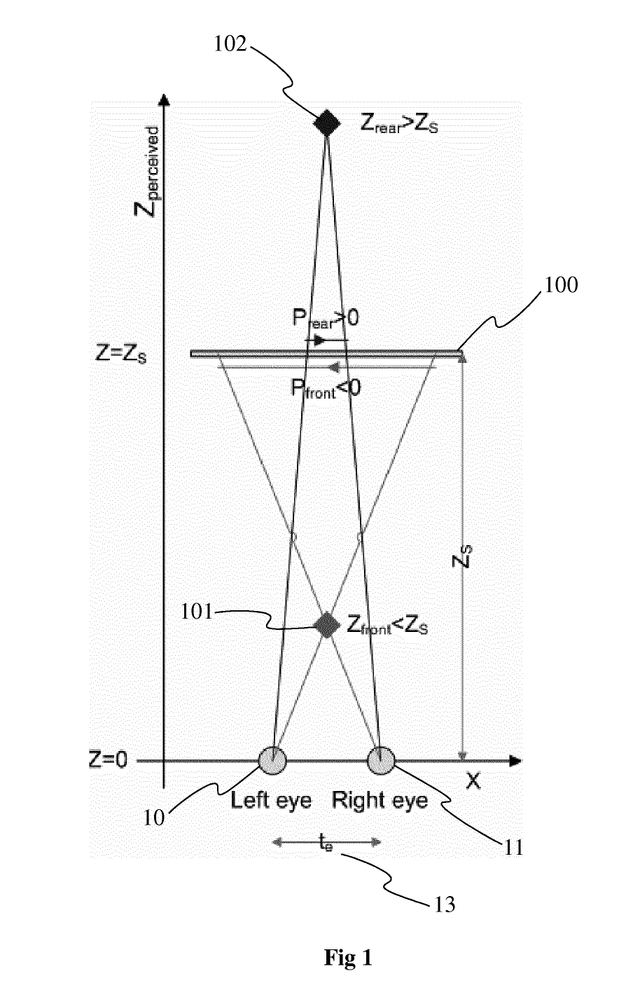

FIG. 1 shows the relationship between the depth perceived by a spectator and the parallax effect between the left and right images viewed by respectively the left eye 10 and the right eye 11 of the spectator looking at a display device or screen 100. In the case of a temporal sequential display of left and right images representative of a same scene according to two different viewpoints (for example captured by two cameras laterally offset from one another by a distance for example equal to 6.5 cm), the spectator is equipped with active glasses for which the left eye occultation and right eye occultation are synchronized respectively with the display of right and left images on an LCD or plasma type screen display device for example. Due to these active glasses, the right eye of the spectator only sees the displayed right images and the left eye only sees the left images. In the case of a spatially interlaced left and right images display, the lines of left and right images are interlaced on the display device in the following manner: one line of the left image then one line of the right image (each line comprising pixels representative of the same elements of the scene filmed by the two cameras) then one line of the left image then one line of the right image and so on. In the case of a display of interlaced lines, the spectator wears passive glasses that enable the right eye to only see the right lines and the left eye to only see the left lines. In this case, the right lines will be polarized according to a first direction and the left lines according to a second direction, the left and right lenses of passive glasses being polarized as a consequence so that the left lens allows the displayed information on the left lines to pass and so that the right lens allows displayed information on the right lines to pass. FIG. 1 shows a display screen or device 100 situated at a distance or depth Zs from a spectator, or more specifically from the orthogonal plane to the viewing direction of the right eye 11 and the left eye 10 of the spectator and comprising the right and left eyes. The reference of the depth, that is to say Z=0, is formed by the eyes 10 and 11 of the spectator. Two objects 101 and 102 are viewed by the eyes of the spectator, the first object 101 being at a depth of Z_{front} less than that of the screen 1 100 (Z_{front}<Zs) and the second object 102 at a depth Zᵣₑₐᵣ greater than that of the screen 100 (Zᵣₑₐᵣ>Zs). In other words, the object 101 is seen in the foreground with respect to the screen 100. So that an object is seen in the background with respect to the screen, it is necessary that the left pixels of the left image and the right pixels of the right image representing this object have a positive disparity, that is to say that the difference of position in X of the display of this object on the screen 100 between the left and right images is positive. So that an object is seen in the foreground with respect to the screen, it is necessary that the left pixels of the left image and the right images of the right image representing this object have a negative disparity, that is to say that the difference in position in X of the display of this object on the screen 100 between the left images and the right images is negative. Finally, so that an object is seen in the plane of the screen, it is necessary that the left pixels of the left image and the right pixels of the right image representing this object have a null disparity, that is to say that the difference in position in X of the display of this object on the screen 100 between the left images and the right images is null. This position difference in X on the screen of left and right pixels representing a same object on the left and right images corresponds to the level of parallax between the left and right images. The relationship between the depth perceived by the spectator of objects displayed on the screen 100, the parallax and the distance to the screen of the spectator is expressed by the following equations:

$$\begin{matrix}{Z}_{P} = \frac{{Z}_{s} * {t}_{e}}{{t}_{e} - P} & Equation 1 \\ P = \frac{{W}_{s}}{{N}_{col}} * d & Equation 2\end{matrix}$$

in which

Zₚ is the perceived depth (in meters, m),

P is the parallax between the left and right images (in meters, m),

d is the transmitted disparity information (in pixels),

tₑ is the inter-ocular distance (in meters, m),

Zₛ is the distance between the spectator and the screen (in meters, m),

Wₛ is the width of the screen (in meters, m),

N_{col} is the number of columns of the display device (in pixels).

Equation 2 enables a disparity (in pixels) to be converted into parallax (in metres).

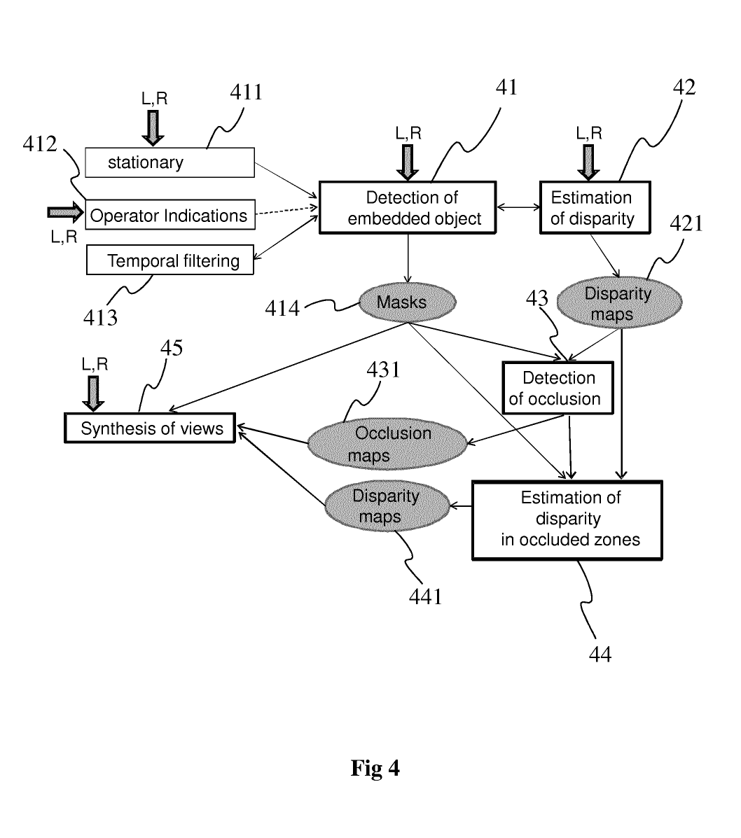

FIG. 4 shows a method for processing a stereoscopic image comprising an embedded object (also called inlayed object or encrusted object), according to a particular and non-restrictive embodiment of the invention. In a first step 41, the position of the embedded object 200 in each of the left 221 and right 231 images of the stereoscopic image is detected. The detection of the position of the embedded object is advantageously achieved via video analysis of each of the left and right images of the stereoscopic image.

Advantageously, the analysis is based on the stationary aspect 411 of the embedded object 200, that is to say that the analysis consists in searching in the images 221, 231 for parts that do not vary in time, that is to say the pixels of images for which the associated video information does not vary in time. The analysis is carried out over a determined time interval or on a number (greater than 2) of temporally successive left images and on a number (greater than 2) of temporally successive right images (corresponding to a temporal filtering 413 over a plurality of images). The number of successive or images (left or right) where the time interval during which the embedded object is searched for advantageously depends on the type of object embedded. For example, if the embedded object is of logo (for example the loge of a television channel broadcasting stereoscopic images) type, the analysis is carried out on a high number of successive images (for example 100 images) or over a significant duration (for example 4 seconds) as a logo is generally called to be displayed permanently. According to another example, if the embedded object is of subtitle type, that is to say an object for which the content varies rapidly in time, the analysis is carried out over a time interval less than (for example 2 seconds) that for a logo or on a number of images (for example 50) less than the number of images for a logo.

According to a variant, the analysis is based on metadata 412 associated with the left and right images, metadata added for example by an operator during the embedding of the object in the original left and right images. The metadata comprise information providing indications to the video analysis engine to target its research, the indications being relative to properties associated with the embedded object, for example information on the approximate position of the embedded object (for example of type left upper corner of the image, lower part of the image, etc.), information on the precise position of the embedded object in the image (for example coordinates of a reference pixel of the embedded object, for example the upper left pixel), information on the form, the colour and/or the transparency associated with the embedded object.

Once the position of the embedded object is detected, masks 414 of left and right images are advantageously generated, the mask of the left image comprising for example a part of the left image comprising the embedded object and the mask of the right image comprising for example a part of the right image comprising the embedded object.

Then, during step 42, the disparity between the left image and the right image (or conversely between the right image and the left image) is estimated. In an advantageous but non-restrictive way, the disparity between the two images is estimated over only a part of the left image and a part of the right image, that is to say a part surrounding the embedded object 200 (for example a box surrounding n×m pixels around the embedded object). Achieving the estimation over only a part of images containing the embedded object offers the advantage of limiting the calculations. The realise the estimation over the totality of images offers the assurance of not losing information, that is to say offers the assurance of having an estimation of the disparity for all of the pixels associated with the embedded object and other objects of the stereoscopic image occluded or partly occluded by the embedded object. The disparity estimation is carried out according to any method known to those skilled in the art, for example by pairing pixels of the left image with pixels of the right image and comparing the video levels associated with each of the pixels, a pixel of the left image and a pixel of the right image having a same video level being paired and same spatial offset according to the horizontal axis (in number of pixels) supplying the disparity information associated with the pixel of the left image (if interested by the disparity map of the left image with respect to the right image for example). Once the estimation of disparity has been carried out, one or several disparity maps 421 are obtained, for example the disparity map of the left image with respect to the right image (providing disparity information representative of the disparity between the left image and the right image) and/or the disparity image of the right image with respect to the left image (providing information of the disparity representative of the disparity between the left image and the right image) and/or one or several partial disparity maps providing disparity information between the part of the left image (respectively the part of the right image) comprising the embedded object with respect to the part of the right image (respectively the part of the left image) comprising the embedded object.

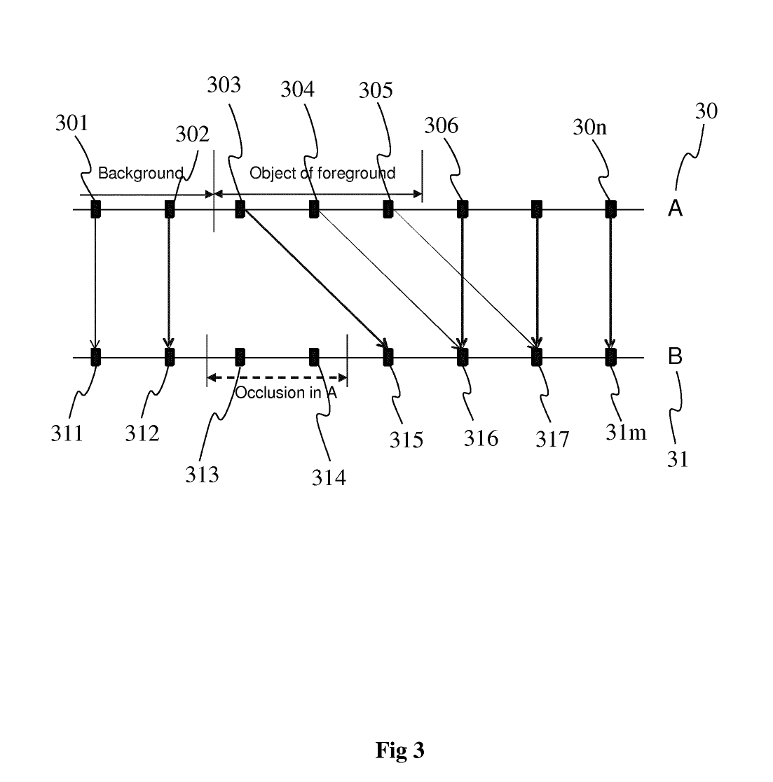

Then, during a step 43, the occlusions in the left image and in the right image are detected. FIG. 3 shows such a method for occlusion determination, according to a particular and non-restrictive embodiment of the invention. FIG. 3 shows a first image A 30, for example the left image (respectively the right image), and a second image B 31 for example the right image (respectively the left image), of a stereoscopic image. The first image 30 comprises a plurality of pixels 301 to 30n and the second image 31 comprises a plurality of pixels 311 to 31m. Using disparity maps 421 estimated previously, that is to say for example from FIG. 3 using the disparity map of the first image A 30 with respect to the second image B 31, for each pixel 30 to 30n of the first image are identified a point of the second image B using disparity information associated with each pixel of the first image A 30 (shown by a vector on FIG. 3) and the pixels 31 to 31m of the second image B 31 closest to these points are identified. The pixels 311, 312, 315, 316, 317 and 31m of the second image B 31 are thus marked. The non-marked pixels 313, 314 of the second image B corresponding to pixels of the second images B 31 occluded in the first image A 30. The part or parts of the second image B 31 occluded in the first image A 30 are thus obtained. The same process is applied to the second image B 31 to determine the part or parts of the first image A 30 occluded in the second image B 31 using the disparity map of the second image B 31 with respect to the first image A30. One or several occlusion maps 431 are obtained as a result of this step 43, for example a first occlusion map comprising the pixels of the right image occluded in the left image and a second occlusion map comprising pixels of the left image occluded in the right image.

During a step 44, the disparity information associated with the pixels of parts occluded in the left image and/or the right image is estimated. The estimation of disparity to be associated with the pixels occluded in the left image and/or right image is obtained according to any method known to those skilled in the art, for example by propagating the disparity information associated with the neighbouring pixels of occluded pixels to these occluded pixels. The determination and association of disparity information with the occluded pixels of left and right images is advantageously realised based of the disparity maps 421 estimated previously and on occlusion maps clearly identifying the occluded pixels in each of the left and right images. New disparity maps 441 (called enriched disparity maps) more complete than the disparity maps 421, as they contain an item of disparity information associated with each pixel of left and right images, or are thus obtained.

During a step 45, the stereoscopic image, that is to say the left and/or right image composing it, is synthesized by modifying the disparity associated with the embedded object 200, that is to say by modifying the depth associated with the embedded object 200. This is obtained by basing on the mask or masks 414 and on the disparity maps 421 or the enriched disparity map or maps 441. To do this, the smallest depth value is found in the box surrounding the embedded object, which is the same as determining the smallest disparity value, that is to say the negative disparity for which the absolute value is maximal in the surrounding box. Advantageously, the determination of the smallest depth value is realised on the disparity map providing an item of disparity information between the part of the left image (respectively the part of the right image) comprising the embedded object with respect to the part of the right image (respectively the part of the left image) comprising the embedded object. According to a variant, the determination of the smallest depth value is carried out on the disparity map providing an item of disparity information between the part of the left image comprising the embedded object with respect to the part of the right image comprising the embedded object and on the disparity map providing an item of disparity information between the part of the right image comprising the embedded object with respect to the part of the left image comprising the embedded object. According to this variant, the smallest depth value corresponds to the smallest depth determined in comparing the two disparity maps on which the determination was carried out. Once the smallest depth value is determined, a depth value lower than this smallest determined depth value is assigned to the pixels of the embedded object 200, that is to say a negative disparity value less than the negative disparity value corresponding to the smallest determined depth value is assigned to the pixels of the embedded object in a way to display the embedded object 200 in the foreground, that is to say in front of all objects of the 3D scene of the stereoscopic image, during the display of the stereoscopic image on a display device. The modification of the depth associated with the embedded object enables the coherence to be re-established between the depth associated with the embedded object and the video information associated with the pixels of the embedded object in the left and right images of the stereoscopic image. Thus, during the display of the stereoscopic image, there will be coherence between the object displayed in the foreground and the displayed video content, the object displayed in the foreground being that for which the associated video content is displayed.

Modifying the depth (that is to say the disparity) associated with the embedded object 200 is the same as repositioning the embedded object in the left image and/or the right image. Advantageously, the position of the embedded object is modified in only one of the two images (left and right). For example, if the position of the embedded object 200 is modified on the left image 221, this is equivalent to offsetting the embedded object 200 towards the right according to the horizontal axis in the left image. If for example the disparity associated with the embedded object is augmented by 5 pixels, this is equivalent to associating video information corresponding to the embedded object 200 to the pixels situated right of the embedded object over a width of 5 pixels, which has the effect of replacing the video content of the left image over a width of 5 pixels to the right of the embedded object 200 (on the height of the embedded object 200). The embedded object being offset to the right, this means that it is then necessary to determine the video information to assign to the pixels of the left image uncovered by the repositioning of the embedded object 200, a band of 5 pixels in width over the height of the object being “uncovered” on the left part occupied by the embedded object in its initial position. The missing video information is advantageously determined by spatial interpolation using video information associated with the pixels surrounding the pixels for which the video information is missing due to the horizontal translation of the embedded object to the left. If however the position of the embedded object 200 is modified on the right image 231, the reasoning is identical except that in this case the embedded object 200 is offset to the left, the part uncovered by the horizontal translation of the embedded object 200 being situated on a zone corresponding to the right part of the embedded object (taken in its initial position) over a width corresponding to the number of pixels by which the disparity is augmented.

According to a variant, the position of the embedded object is modified in the left image and in the right image, for example by offsetting the embedded object in the left image by one or several pixels to the right according to the horizontal axis and by offsetting the embedded object 200 in the right image by one or several pixels to the left according to the horizontal axis. According to this variant, it is necessary to re-calculate the video information for the uncovered pixels by the repositioning of the embedded object in each of the left and right images. This variant however has the advantage that the uncovered zones in each of the images are less wide than in the case where the position of the embedded object is modified only in one of the left and right images, which reduces possible errors engendered by the spatial interpolation calculation of the video information to be associated with the uncovered pixels. In fact, the bigger the number of pixels to be interpolated on the image, the greater the risk of assigning erroneous video information, particularly for the pixels situated at the centre of the zone for which the video information is missing, these pixels being relatively far from pixels of the periphery for which video information is available.

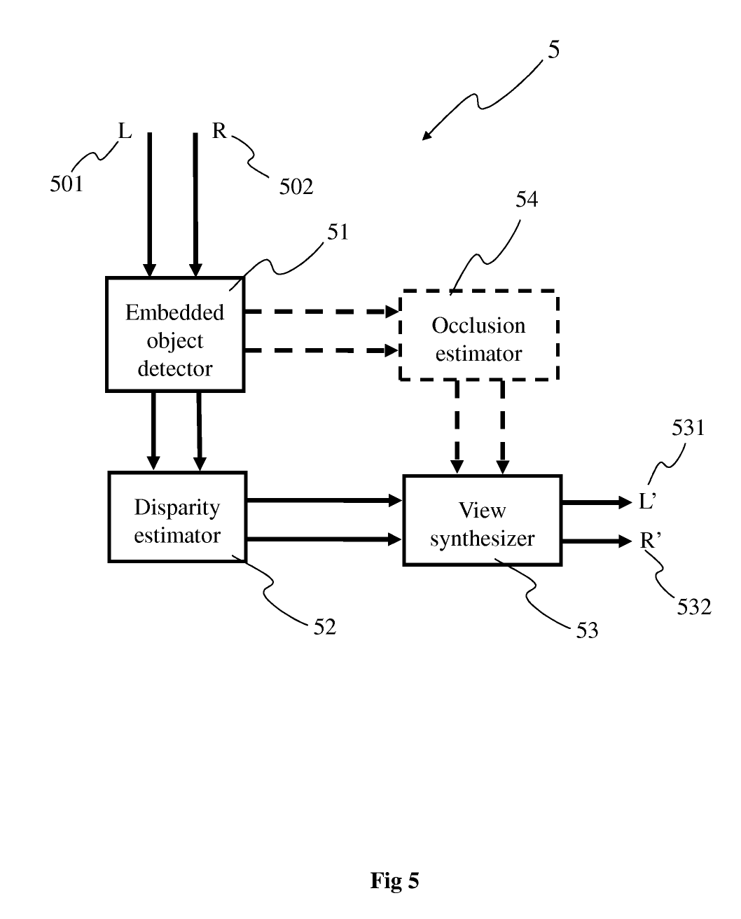

FIG. 5 diagrammatically shows a hardware embodiment of an image processing unit 5, according to a particular and non-restrictive embodiment of the invention. The processing unit 5 takes for example the form of a programmable logical circuit of type FPGA (Field-Programmable Gate Array) for example, ASIC (Application-Specific Integrated Circuit) or a DSP (Digital Signal Processor).

The processing unit 5 comprises the following elements:
an embedded object detector 51,
a disparity estimator 52,
a view synthesizer 53, and
an occlusion estimator 54.

A first signal L 501 representative of a first image (for example the left image 221) and a second signal R 502 representative of a second image (for example the right image 231), for example acquired by respectively a first acquisition device and a second acquisition device, are provided at input of the processing unit 3 to an embedded object detector 51. The embedded object detector advantageously detects the position of one or several embedded objects contained in each of the first and second images basing the analysis on the search for stationary objects and/or objects having particular properties (for example a determined form and/or a determined colour and/or a determined level of transparency and/or a determined position). One or several masks are found at the output of the embedded object detector, for example a mask for the first image and a mask for the second image, each mask corresponding to a part of the first image (respectively the second image) comprising the detected embedded object(s) (corresponding for example to a zone of the first image (respectively the second image) of m×n pixels surrounding each embedded object). According to a variant, at output from the embedded object detector 51 are found the first image 501 and the second image 502, with each image is associated an item of information representative of the position of the detected embedded object (corresponding for example to the coordinates of a reference pixel of the detected embedded object (for example the upper left pixel of the embedded object) as well as the width and height expressed in pixels of the embedded object or of a zone comprising the embedded object).

The disparity estimator 52 determines the disparity between the first image and the second image and/or between the second image and the first image. According to an advantageous variant, the estimation of disparity is only carried out on the parts of the first and second image comprising the embedded object(s). At output of the disparity estimator 52 are found one or several total disparity maps (if the disparity estimation is carried out over the totality of first and second images) or one or several partial disparity maps (is the disparity estimation is carried out on a part only of first and second images).

Using disparity information from the disparity estimator 52, a view synthesizer 53 determines the minimal depth value corresponding to the smallest disparity value (that is to say the negative disparity value for which the absolute value is maximal) present in the disparity map(s) received in a zone surrounding and comprising the embedded object (for example a zone surrounding the object with a margin of 2, 3, 5 or 10 pixels above and below the embedded object and a margin of 1, 10, 20 or 50 pixels left and right of the embedded object). The view synthesizer 53 modifies the depth associated with the embedded object in such a way that the new depth value associated with the embedded object is displayed in the foreground in the zone of the stereoscopic image that comprises it during the display of the stereoscopic image formed from the first image and the second image. The view synthesizer 53 consequently modifies the video content of the first image and/or the second image, offsetting the embedded object in a direction according to the horizontal axis in the first image and/or offsetting the embedded object according to a horizontal axis in the second image in the opposite direction to that of the first image in a way to augment the disparity associated with the embedded object to display it in the foreground. At output from the view synthesizer 53 are found a modified first image L′ 531 and the source second image R 502 (in the case where the position of the embedded object was only offset on the first source image L 501) or the first source image L 501 and a second modified image R′ 532 (in the case where the position of the object was only offset on the second source image R 502) or the first modified image L′ 531 and the second modified image R′ 532 (in the case where the position of the embedded object was modified in the two source images). Advantageously the view synthesizer comprises a first interpolator enabling the disparity to be associated with the pixels of the first image and/or the second image “uncovered” during the modification of the position of the embedded object in the first image and/or the second image to be estimated. Advantageously the view synthesizer comprises a second interpolator enabling the video information to be associated with the pixels of the first image and/or the second image “uncovered” during the modification of the position of the embedded object in the first image and/or the second image to be estimated.

According to an optional variant corresponding to a particular embodiment of the invention, the processing unit 5 comprises an occlusion estimator 54 to determine the pixels of the first image that are occluded in the second image and/or the pixels of the second image that are occluded in the first image. Advantageously, the determination of pixels occluded is carried out in the neighbouring area of the embedded object only being based on the information on the position of the embedded object provided by the embedded object detector. According to this variant, one or several occlusion maps comprising information on the pixel or pixels of an occluded image in the other of the two images is transmitted to the view synthesizer 53. Using this information, the view synthesizer 53 launches the process of modification of the depth assigned to the embedded object if and only if the position of pixels occluded in the first image and/or in the second image correspond to a determined model, the determined model belonging for example to a library of models stored in a memory of the processing unit 5. This variant has the advantage of validating the presence of an embedded object in the stereoscopic image comprising the first and second image before launch of the calculations necessary for the modification of the position of the embedded object at the level of the view synthesizer. According to another variant, the comparison between the position of pixels occluded and the determined model or models is realised by the occlusion estimator 54, the result of the comparison being transmitted to the embedded object detector to validate or invalidate the embedded object. In the case of invalidation, the detector 51 recommences the detection process. Advantageously, the detector recommences the detection process a determined number of times (for example 3, 5 or 10 times) before stopping the search for an embedded object.

According to an advantageous variant, the processing unit 5 comprises one or several memories (for example of RAM (Random Access Memory) or flash type able to memorise one or several first source images 501 and one or several source images 502 and a synchronisation unit enabling the transmission to be synchronised of one of the source images (for example the second source image) with the transmission of a modified image (for example the first modified image) for the display of the new stereoscopic image, for which the depth associated with the embedded object was modified.

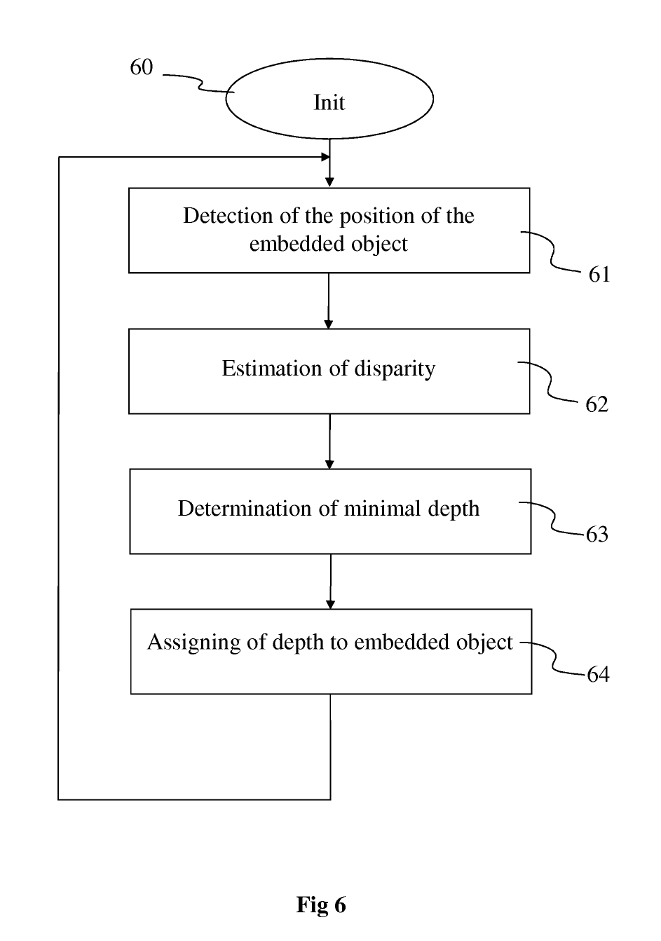

FIG. 6 shows a method for processing a stereoscopic image implemented in a processing unit 5, according to a first non-restrictive particularly advantageous embodiment of the invention.

During an initialisation step 60, the different parameters of the processing unit are updated, for example the parameters representative of the localisation of an embedded object, the disparity map or maps generated previously (during a previous processing of a stereoscopic image or of a previous video stream).

Then during a step 61, the position of an embedded object in the stereoscopic image, for example an object added in post production to the initial content of the stereoscopic image. The position of the embedded object is advantageously detected in the first image and in the second image that compose the stereoscopic image, the display of the stereoscopic image being obtained by the display of the first image and the second image (for example sequential display), the brain of a spectator looking at the display device making the synthesis of the first image and the second image to arrive at the display of the stereoscopic image with 3D effects. The determination of the position of the embedded object is obtained by analysis of the video content (that is to say the video information associated with the pixels of each image, that is to say for example a grey level value coded for example on 8 bits or 12 bits for each primary colour R, G, B or R, G, B, Y (Y is Yellow) associated with each pixel of each first and second image). The information representative of the position of the embedded object is for example formalised by an item of information on the coordinates of a particular pixel of the embedded object (for example the upper left or right pixel, the pixel situated at the centre of the embedded object). According to a variant, the information representative of the position of the embedded object also comprises an item of information on the width and the height of the object embedded in the image, expressed in number of pixels.

The detection of the position of the embedded object is advantageously obtained by searching for the fixed parts in the first image and in the second image, that is to say the parts for which the associated video content is fixed (or varying little, that is to say with a minimal video information variation associated with the pixels, that is to say less than a threshold value, for example a value variation less than a level equal to 5, 7 or 10 on a scale of 255 grey levels). To do this, the video content of several first temporally successive images is compared as well as the content of several temporally successive second images. The zone or zones of first and second images for which the video content associated with pixels of these zone varies little or nota at all advantageously corresponds to an embedded object. Such a method enables any embedded object for which the content varies little or not at all over time to be detected, that is to say any embedded object stationary in an image such as for example the channel logo of a television channel broadcasting the stereoscopic image or the score of a sporting match or any element giving information on the displayed content (such as for example the recommended age limit for viewing the displayed content). Such a detection of the embedded object is thus based on the stationary aspect of the embedded object over a determined time interval, corresponding to the duration of the display of several first images and several second images.

According to a variant, the detection of the position of the embedded object is obtained while searching for pixels having one or several specific properties, this property or these properties being associated with the embedded object. The specific property or properties advantageously belong to a list of properties comprising:
the colour of the embedded object, that is to say the value of the video information associated with each colour component RGB or RGBY for example) enabling the colour of the embedded object to be obtained,
the form, that is to say the general form, approximate or precise of the embedded object (for example a circle if the embedded object corresponds to an item of information on age limit, the form of a logo, etc.),
the transparency level associated with the embedded object, that is to say the value representative of the transparency associated with the pixels of the embedded object (coded on the channel α in a RGBα coding of video information),
an index on the position of the embedded object in the first image and/or in the second image, for example the coordinates x, y of a pixel of the embedded object, for example the pixel positioned top left of the object or right bottom or centre of the object.
   The search for the position of the embedded object is carried out on the basis of a single property of the list above or of several properties of the list combined together, for example on the colour and the level of transparency or the form and the colour. The property or properties associated with the embedded object are advantageously added to the video content of first and second images in the form of metadata in an associated channel and are for example found by the post-production operator having added the embedded object to the initial content of the stereoscopic image. Basing the search for an embedded object on one or several properties of the list enables detection of embedded objects in motion in a consecutive series of first images (respectively second images), the search for an embedded object in motion not being able to be based on the stationary aspect of this embedded object.

According to another variant, the detection of the embedded object is carried out by combining the search for fixed part(s) in the first and second images with the search for pixels having one or several specific properties.

Then, during a step 62, an item of disparity information representative of the disparity between the first image and the second image is estimated, over at least a part of the first and second images comprising the embedded object for which the position was detected in the preceding step. The estimation of disparity is for example carried out on a part of the first and second images surrounding the embedded object, for example on a bounding box or on a wider part comprising the embedded object and a part surrounding the embedded object of a given width (for example 50, 100 or 200 pixels around the peripheral limits of the embedded object). The estimation of disparity is carried out according to any method known to those skilled in the art. According to a variant, the estimation of disparity is carried out on the entire first image with respect to the second image. According to another variant, the estimation of disparity is carried out on all or part of the first image with respect to the second image and on all or part of the second image with respect to the first image. According to this other variant, two disparity maps are obtained, a first associated with the first image (or with a part of the first image according to the case) and a second associated with the second image (or a part of the second image according to the case).

Then during a step 63, a minimal depth value corresponding to the smallest depth value in the part of the first image (and/or of the second image) comprising the embedded object is determined according to the disparity information estimated previously (see equations 1 and 2 explaining the relationship between depth and disparity with respect to FIG. 1). The determination is advantageously realised in a zone of the first image (and/or of the second image) surrounding the embedded object and not all of the first image (and/or all of the second image). The zone of the image where incoherencies could appear between the disparity associated with the embedded object and video information associated with the pixels of the embedded object is that surrounding the object, that is to say the zone where occlusions between the embedded object and another object of the 3D scene shown in the stereoscopic image could appear.

Finally, during a step 64, a new depth is assigned to the embedded object, the value of the new depth assigned being less than the minimal depth value determined in the zone of the first image and/or the second image comprising the embedded object. Modifying the depth associated with the embedded object is a way so that it is displayed in the foreground in the zone of the image that contains it enables coherency to be returned with the displayed video information which is that of the embedded object, whatever the depth associated with the embedded object, as the object has been embedded in the first and second images of the stereoscopic image by modifying the video information of pixels concerned by video information corresponding to the embedded object.

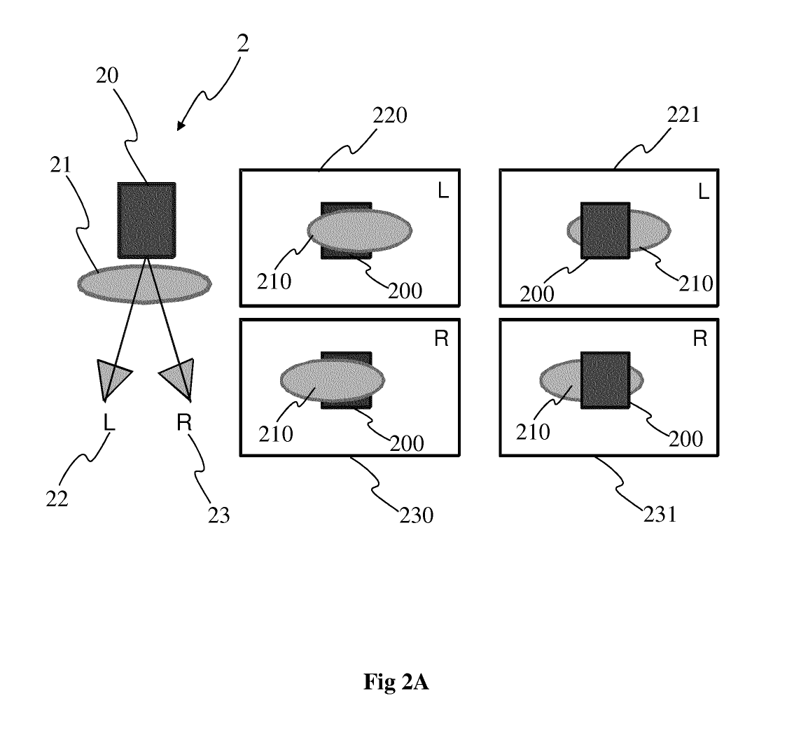

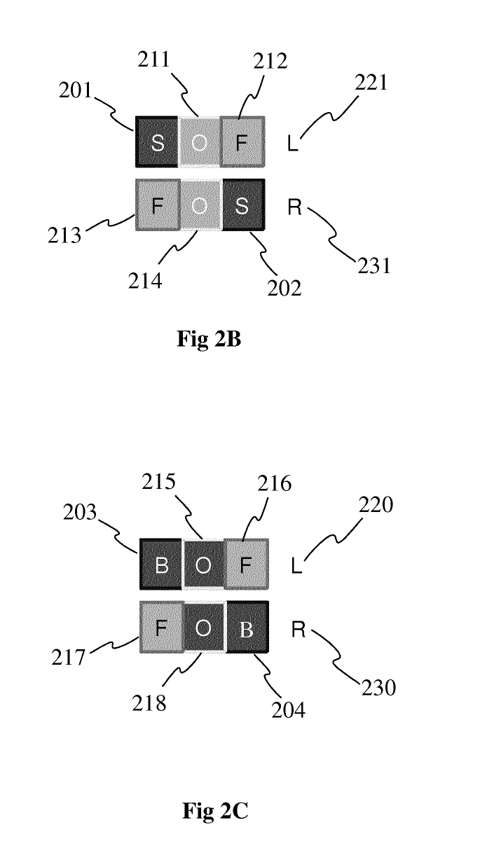

According to an embodiment, the pixels of the first image that are occluded in the second image and the pixels of the second image that are occluded in the first image are determined, for example according to the method described with respect to FIG. 3. A schema of the disposition of pixels occluded in the first image and in the second image is obtained with respect to the position of the embedded object, as shown with respect to FIG. 2B. FIG. 2B shows, according to a particular and non-restrictive embodiment of the invention, the positioning of pixels occluded in the first image 221 and in the second image 231 relative to the position of pixels of the embedded object 200 and an object 210 of the 3D scene for which the associated depth is less than that of the embedded object 200 prior to modification of the depth assigned to the embedded object, called the new depth. Contrary to a case where there is coherence between the disparity information and the video information (that is to say in the case where the video information associated with the pixels of an image correspond to the video information associated with the objects that will be displayed in the foreground, that is to say the objects for which the associated depth is smallest), a pixel 214 of the second image 231 (right image according to the example of FIG. 2B) occluded in the first image 221 (the left image according to the example of FIG. 2B) is positioned left of a pixel 202 of the embedded object and right of a pixel 213 of the object 210 and a pixel 211 of the first image 221 occluded in the second image 231 is positioned right of a pixel 201 of the embedded object 200 and left of a pixel 212 of the object 210. In the presence of such a determined model representing the positioning of pixels occluded with respect to the pixels of the embedded object, there is confirmation that an object has been embedded in the stereoscopic image with a disparity non-coherent with the other objects of the 3D scene situated in a same zone of the image. By comparing the position of occluded pixels with respect to the embedded object with such a model and when the comparison is positive (that is to say that the positioning of occluded pixels corresponds to the model), enables confirmation that an object has been embedded in the image. Such a comparison enables the detection of the position of the embedded object described in step 61 to be validated or invalidated (if the result of the comparison is negative).

Steps 61 to 64 are advantageously reiterated for each stereoscopic image of a video sequence comprising several stereoscopic images, each stereoscopic image being formed of a first image and a second image. According to a variant, steps 61 to 64 are reiterated every n stereoscopic image, for example every 5, 10 or 20 stereoscopic images.

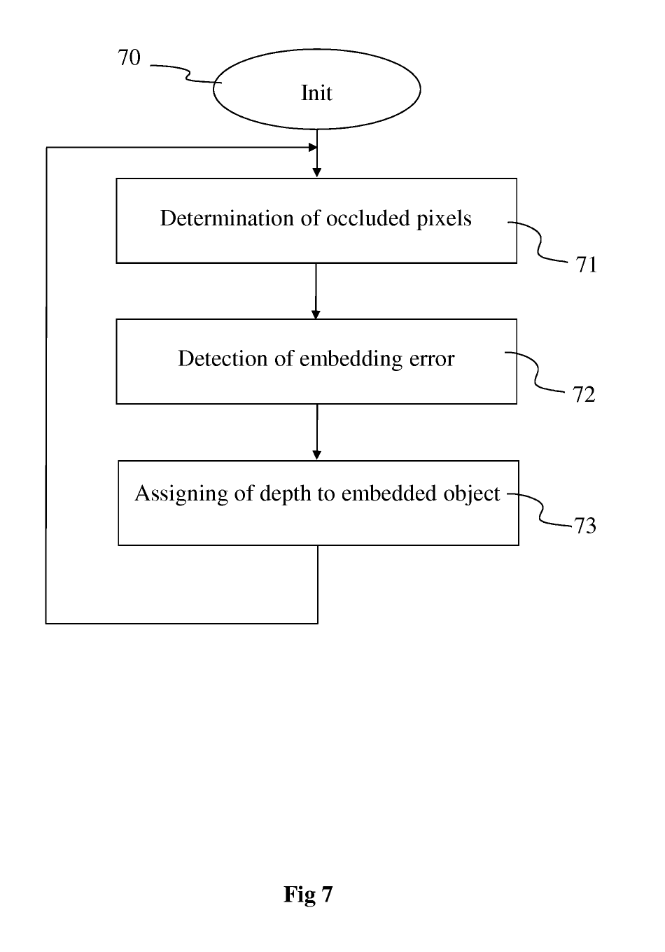

FIG. 7 shows a method for processing a stereoscopic image implemented in a processing unit 5, according to a second non-restrictive particularly advantageous embodiment of the invention.

During an initialisation step 70, the different parameters of the processing unit are updated, for example the disparity map or maps generated previously (during a previous processing of a stereoscopic image or of a previous video stream).

Then, during a step 71, the pixel or pixels of the first image (221) that are occluded in the second image (231) are determined, for example as described in respect of FIG. 3. According to an optional variant, the pixel or pixels of the second image (231) that are occluded in the first image (221) are also determined.

Then, during a step 72, a possible embedding error of the embedded object is detected. To do this, for at least one horizontal line of pixels of the first image comprising a group of pixels occluded in the second image, it is determined if the group of occluded pixels corresponds or not to the embedded object. The depth values associated with the pixels of the line that surround the group of occluded pixels and adjacent to the occluded pixels are also compared with each other, that is to say the depth values associated with the pixels adjacent to the group of occluded pixels situated right of the group of pixels are compared with the depth values associated with the pixels adjacent to the group of occluded pixels situated left of the group of occluded pixels. According to the result of the comparison of depth values and the membership (or non-membership) of the group of occluded pixels to the embedded object, an error linked to the embedding of the object is detected or not. By group of occluded pixels is understood a set of adjacent pixels of the first image occluded in the second image along a horizontal line of pixels. According to a variant, the group of occluded pixels only comprises a single pixel of the first image occluded in the second image. An embedding error of the embedded object corresponds advantageously to the detection of a conflict between the depth and the occlusion, between the embedded object and the original content of the stereoscopic image (that is to say before embedding). This conflict is for example due to the fact that the embedded object partially occluded another object of the stereoscopic image that is moreover situated closer to the observer (or cameras). In other words, this other object has a lesser depth than the embedded object and is nevertheless partially occluded by it, as shown with respect to FIG. 2A.

An embedding error associated with the embedded object is for example detected in the following case:
if the first image (221) is a left image, an embedding error is detected if:
   the group of at least one pixel occluded in the second image (231) belongs to the same object as the pixel adjacent to the group and situated right of the group, or
   the depth associated with the pixel adjacent to the group and situated left of the group is less than the depth associated with the pixel adjacent to the group and situated right of the group, the group belonging to the same object as the pixel adjacent to the group and situated left of the group.
if the first image (221) is a right image, an embedding error is detected if:
   the group of at least one pixel occluded in the second image (231) belongs to the same object as the pixel adjacent to the group and situated left of the group, or
   the depth associated with the pixel adjacent to the group and situated right of the group is less than the depth associated with the pixel adjacent to the group and situated left of the group, the group belonging to the same object as the pixel adjacent to the group and situated right of the group.

Some examples are shown with respect to FIGS. 2B and 2C. FIG. 2B shows two particular examples of schemas of the disposition of pixels on a line of pixels comprising pixels occluded (noted as O) when there is a conflict between the depth and occlusion, that is to say when there is an embedding error of the object known as the embedded object in the stereoscopic image. FIG. 2C shows to schemas of disposition of pixels on a line of pixels comprising pixels occluded when there is no conflict between depth and occlusion, that is to say when there is no error at the level of embedding of the object.

FIG. 2C shows the positioning of pixels occluded in the first image 220 and in the second image 230 relative to the position of pixels of the embedded object 200 and an object 210 of the 3D scene for which the depth associated is less than that of the embedded object. The group of pixels O 215 of the first image L 220 occluded in the second image R 230 is bounded on the left by a group of adjacent pixels B 203 belonging to the background, that is to say to the object 200, and on its right by a group of adjacent pixels F 216 belonging to the foreground, that is to say to the object 210. The depth associated with the pixels B 203 is greater than the depth associated with the pixels F 216 and the occluded pixels O 215 belong to the object of the background, that is to say to the embedded object 200. According to this example, the first image L 220 is a left image and the schema of positioning of the pixels B, O, F corresponds to a case where there is no embedding error of the object 200. The group of pixels O 218 of the second image R 230 occluded in the first image L 220 is bounded on its left by a group of adjacent pixels F 217 belonging to the foreground, that is to say to the object 210, and on its right by a group of adjacent pixels B 204 belonging to the background, that is to say to the object 200. The depth associated with the pixels F 217 is greater than the depth associated with the pixels B 204 and the occluded pixels O 218 belonging to the object of the background, that is to say the embedded object 200. According to this example, the second image R 230 is a right image and the schema of positioning of pixels F, O, B corresponds to the case where there is no embedding error of the object 200. These two examples advantageously correspond to the predetermined positioning models of pixels bounding the occluded pixels when there is no embedding error of the object 200. When the positioning of pixels bounding a group of occluded pixels does not respect a predetermined positioning model corresponding to one of these two schemas of FIG. 2C, then there is an embedding error.

FIG. 2B shows, according to two particular and non-restrictive embodiments of the invention, the positioning of pixels occluded in the first image 221 and in the second image 231 relative to the position of pixels of the embedded object 200 and an object 210 of the 3D scene for which the associated depth is less than that of the embedded object 200, the video information corresponding to the embedded object having been assigned to the pixels of the image in a way to display the embedded object in the foreground. The group of pixels O 211 of the first image L 221 occluded in the second image R 231 is bounded on its left by a group of adjacent pixels S 201 belonging to the embedded object 200, and on its right by a group of adjacent pixels F 212 belonging to the object 210 that should be found in the foreground, the depth associated with the object 210 being less than the depth associated with the embedded object 200. The depth associated with the pixels S 201 is greater than the depth associated with the pixels F 212 and the occluded pixels O 211 belonging to the object that should be found in the foreground, that is to say the object 210. According to this example, the first image L 221 is a left image and the schema of positioning of pixels S, O, F corresponds to the case where there is an embedding error of the object 200. The group of pixels O 214 of the second image R 231 occluded in the first image L 221 is bounded on its left by a group of adjacent pixels F 213 belonging to the object 210 that should be found in the foreground, and on its right by a group of adjacent pixels S 202 belonging to the object 200 that should be found in the background. The depth associated with the pixels F 213 is less than the depth associated with the pixels S 202 and the occluded pixels O 214 belonging to the object 210 that should be found in the foreground. According to this example, the second image R 231 is a right image and the schema of positioning of pixels F, O and S corresponds to the case where there is an embedding error of the object 200.

Finally, during a step 73, a new depth is assigned to the embedded object if an embedding error is detected, the value of the new assigned depth being less than a minimal depth value. The minimal depth value advantageously corresponds to the smallest depth value associated with the pixels bounding the group pixels occluded and adjacent to the group of occluded pixels, in a way to return the embedded object to the foreground, coherent with the video information associated with the pixels of first and second images at the level of the embedded object.

Advantageously, the membership of the group of occluded pixels to the embedded object is determined by comparison of at least one property associated with the group of occluded pixels to at least one property associated with the pixels of the embedded object. The properties of pixels correspond for example to the video information associated with the pixels (that is to say colour) associated with pixels and/or a motion vector associated with the pixels. An occluded pixel belongs to the embedded object if its colour is identical or almost identical to that of pixels of the embedded object and/or if an associated motion vector is identical or almost identical to that associated with the pixels of the embedded object.

The determination of the occluded pixel(s) is advantageously realised on the part of the image comprising the embedded object, the position of the embedded object being known (for example due to meta data associated with the stereoscopic image) or determined as described in step 61 of FIG. 6.

Advantageously, a disparity map is associated with each first and second image and received with video information associated with each first and second image. According to a variant, the disparity information is determined on at least the part f the first and second images that comprises the embedded object.

Steps 71 to 73 are advantageously reiterated for each stereoscopic image of a video sequence comprising several stereoscopic images, each stereoscopic image being formed of a first image and a second image. According to a variant, steps 71 to 73 are reiterated every n stereoscopic images, for example every 5, 10 or 20 stereoscopic images.

Naturally, the invention is not limited to the embodiments previously described.

In particular, the invention is not restricted to a method for processing images but extends to the processing unit implementing such a method and to the display device comprising a processing unit implementing the image processing method.

The invention also is not limited to the embedding of an object in the plane of the stereoscopic image but extends to the embedding of an object at a determined depth (in the foreground, that is to say with a negative disparity or in the background, that is to say with a positive disparity), a conflict appearing if another object of the stereoscopic image is positioned in front of the embedded object (that is to say with a depth less than that of the embedded object) and if the video information associated with the embedded object is embedded on left and right image of the stereoscopic image without taking account of the depth associated with the embedded object.

Advantageously, the stereoscopic image to which is added the embedded object comprises more than two images, for example three, four, five or ten images, each image corresponding to a different viewpoint of the same scene, the stereoscopic image being then adapted to an auto-stereoscopic display.

Advantageously, the invention is implemented on transmission of the stereoscopic image or images comprising the embedded object to a receiver adapted for decoding of the image for displaying or on the reception side where the stereoscopic images comprise the embedded object, for example on the display device or a set-top box associated with the display device.

1. Method for processing a stereoscopic image, said stereoscopic image comprising a first image and a second image, said stereoscopic image comprising an embedded object, the object being embedded onto the first image and onto the second image while modifying the initial video content of pixels of the first image and of the second image associated with the embedded object, the method comprising a step for:
determining at least one pixel of the first image occluded in the second image on at least part of the first and second images comprising said embedded object,
wherein said method further comprises the steps of:
for at least one horizontal line of pixels of the first image comprising a group of at least one occluded pixel, detecting an embedding error of said object according to membership of said group to the embedded object and depth values associated with the pixels bounding said group and adjacent to said group on said at least one horizontal line,
assigning of a depth to the embedded object for which the value is less than a minimal depth value if an embedding error is detected, the minimal depth value corresponding to the smallest depth value associated with the pixels bounding said group and adjacent to said group on the at least one horizontal line.

2. Method according to claim 1, wherein:
if the first image is a left image, an embedding error is detected if:
the group of at least one occluded pixel belongs to the same object as the pixel adjacent to the group and situated right of the group, or
the depth associated with the pixel adjacent to the group and situated left of the group is less than the depth associated with the pixel adjacent to the group and situated right of the group, the group belonging to the same object as the pixel adjacent to the group and situated left of the group.
if the first image is a right image, an embedding error is detected if:
the group of at least one occluded pixel belongs to the same object as the pixel adjacent to the group and situated left of the group, or
the depth associated with the pixel adjacent to the group and situated right of the group is less than the depth associated with the pixel adjacent to the group and situated left of the group, the group belonging to the same object as the pixel adjacent to the group and situated right of the group.

3. Method according to claim 1, wherein membership of said group to the embedded object is determined by comparison of at least one property associated with said group and to the pixels of the embedded object, the at least one property belonging to a set of properties comprising:
a colour,
an associated motion vector.

4. Method according to claim 1, wherein the method comprises a step of detection of the position of the embedded object based on the stationary aspect of the embedded object over a determined time interval.

5. Method according to claim 1, wherein the method comprises a step of detection of the position of the embedded object based on at least one associated property of said embedded object, the at least one associated property of said embedded object belonging to a set of properties comprising:
a colour,
a form,
a transparency level,
a position index in the first image and/or the second image.

6. Method according to claim 1, wherein the method also comprises a step of determination of an item of disparity information representative of disparity between the first image and the second image on at least one part of the first and second images comprising said embedded object.

7. Method according to claim 1, wherein the assigning of a depth to the embedded object is carried out via horizontal translation of pixels associated with said embedded object in at least one of the first and second images, an item of video information and an item of disparity information being associated with the pixels of the at least one of the first and second images uncovered by the horizontal translation of pixels associated with the embedded object by spatial interpolation of video information and disparity information associated with the neighbouring pixels of uncovered pixels.

8. Module for processing a stereoscopic image, said stereoscopic image comprising a first image and a second image, said stereoscopic image comprising an embedded object, the object being embedded onto the first image and onto the second image while modifying the initial video content of pixels of the first image and of the second image associated with the embedded object, the module comprising:
means for determining at least one pixel of the first image occluded in the second image on at least a part of the first and second images comprising said embedded object,
wherein the module also comprises:
means for detecting an embedding error of said object, for at least one horizontal line of pixels of the first image comprising a group of at least one occluded pixel, according to membership of said group to the embedded object and depth values associated with the pixels bounding said group and adjacent to said group on said at least one horizontal line,
the image processing module comprising in addition:
means for assigning of a depth to the embedded object for which the value is less than a minimal depth value if an information error is detected, the minimal depth value corresponding to the smallest depth value associated with the pixels bounding said group and adjacent to said group on the at least one horizontal line.

9. Module for processing according to claim 8, wherein:
if the first image is a left image, an embedding error is detected if:
the group of at least one occluded pixel belongs to the same object as the pixel adjacent to the group and situated right of the group, or
the depth associated with the pixel adjacent to the group and situated left of the group is less than the depth associated with the pixel adjacent to the group and situated right of the group, the group belonging to the same object as the pixel adjacent to the group and situated left of the group.
if the first image is a right image, an embedding error is detected if:
the group of at least one occluded pixel belongs to the same object as the pixel adjacent to the group and situated left of the group, or
the depth associated with the pixel adjacent to the group and situated right of the group is less than the depth associated with the pixel adjacent to the group and situated left of the group, the group belonging to the same object as the pixel adjacent to the group and situated right of the group.

10. Module for processing according to claim 8, wherein it also comprises means for determining the membership of said group to the embedded object, the occlusion estimator comprising a comparator of at least one property associated with said group and to the pixels of the embedded object, the at least one property belonging to a set of properties comprising:
a colour,
an associated motion vector.

11. Module for processing according to claim 8, wherein the module comprises a detector of embedded objects configured to detect the position of the embedded object based on the stationary aspect of the embedded object over a determined time interval.

12. Module for processing according to claim 8, wherein the module comprises a detector of embedded objects configured to detect the position of the embedded object based on at least one property associated with said embedded object, the at least one property associated with said embedded object belonging to a set of properties comprising:
a colour,
a form,
a transparency level,
a position index in the first image and/or the second image.

13. Module for processing according to at claim 8, wherein the module also comprises a disparity estimator configured to determine an item of disparity information representative of disparity between the first image and the second image on at least one part of the first and second images comprising said embedded object.

14. Module for processing a stereoscopic image, said stereoscopic image comprising a first image and a second image, said stereoscopic image comprising an embedded object, the object being embedded on a first image and on a second image modifying the initial video content of pixels of the first image and the second image associated with the embedded object, the module comprising an occlusion estimator configured to detect at least one pixel of the first image occluded in the second image on at least part of the first and second images comprising said embedded object,
wherein:
the occlusion estimator is configured to detect an embedding error of said object, for at least one horizontal line of pixels of the first image comprising a group of at least one occluded pixel, according to membership of said group to the embedded object and depth values associated with the pixels bounding said group and adjacent to said group on said at least one horizontal line,
the image processing module further comprising:
a view synthesizer configured to assign a depth to the embedded object for which the value is less than a minimal depth value if an information error is detected, the minimal depth value corresponding to the smallest depth value associated with the pixels bounding said group and adjacent to said group on said at least one horizontal line.
